(19) United States
(12) Patent Application Publication
(10) Pub. No.: US 2026/0322568 A1
(43) Pub. Date: Oct. 15, 2026

(54) SENSING APPARATUS FOR LOW-COMPLEXITY SENSING BASED ON OTFS SIGNAL AND METHOD OF OPERATING THE SENSING APPARATUS

(71) Applicant: Samsung Electronics Co., Ltd., Suwon-si (KR)

(72) Inventors: Jeonghoon PARK, Seoul (KR); Seongcheol KIM, Seoul (KR)

(73) Assignees: Samsung Electronics Co., Ltd., Suwon-si (KR); SEOUL NATIONAL UNIVERSITY R&DB FOUNDATION, Seoul (KR)

(21) Appl. No.: 19/641,940

(22) Filed: Apr. 8, 2026

(30) Foreign Application Priority Data
Apr. 9, 2025 (KR) 10-2025-0046402

(51) Int. Cl. H04L 5/00; H04L 25/03

(52) U.S. Cl. CPC H04L 5/0094; H04L 25/03821; H04L 25/03019; H04L 2025/03414

(57) ABSTRACT

Provided is a sensing apparatus including a transmitting/receiving circuit configured to transmit an orthogonal time frequency space (OTFS) transmitted signal to a target, and receive an OTFS received signal, the OTFS received signal corresponding to the OTFS transmitted signal having been reflected by the target, and processing circuitry configured to calculate a first spectrum matrix in a delay-Doppler domain based on the OTFS transmitted signal and the OTFS received signal, and estimate a first distance to the target and a first velocity of the target based on a plurality of first elements included in the first spectrum matrix respectively corresponding to at least some of a first plurality of grids configured to divide uniformly a total search region, and the total search region corresponding to a bandwidth and a frame time of the OTFS transmitted signal in the delay-Doppler domain.

### CROSS-REFERENCE TO RELATED APPLICATION

This application is based on and claims priority under 35 U.S.C. § 119 to Korean Patent Application No. 10-2025-0046402, filed on Apr. 9, 2025, in the Korean Intellectual Property office, the disclosure of which is incorporated by reference herein in its entirety.

### BACKGROUND

The inventive concepts relate to a sensing apparatus, and more particularly, to a sensing apparatus configured to sense a target by applying low-complexity computation based on an orthogonal time frequency space (OTFS) signal.

New proposals and research are actively being conducted on communication-radar compatible systems that attempt to perform both communication and radar functions by sharing a single signal wave. When performing a radar function for sensing a target based on an orthogonal frequency division multiplexing (OFDM) signal that may be used in a wireless communication system, target sensing performance may be deteriorated by inter-carrier interference (ICI) caused by a Doppler element and/or inter-symbol interference (ISI) resulting from a multipath. In particular, signals received after being reflected by a fast-moving target may have high Doppler elements, and thus when a target is sensed based on an OFDM signal, the peak element of the target decreases, the overall noise level increases, and target sensing is affected.

To address the above-described challenges, the OTFS signal may be used. When a target is sensed by using the OTFS signal, sensing performance may be improved by minimizing (or reducing) the effects of ICI and/or ISI by efficiently separating and processing delays and Doppler elements for each of multiple paths by using a modulation operation in a delay-Doppler domain.

However, when a target is sensed by using the OTFS signal, the computation complexity may increase because the target is sensed by separating each of the multiple paths using a search algorithm in the delay-Doppler domain corresponding to a two-dimensional region.

### SUMMARY

The inventive concepts provide a sensing apparatus configured to sense a target by using a lower-complexity computation based on an orthogonal time frequency space (OTFS) signal and a method of operating the sensing apparatus.

According to an aspect of the inventive concepts, there is provided a sensing apparatus including a transmitting/receiving circuit configured to transmit an orthogonal time frequency space (OTFS) transmitted signal to at least one target, and receive an OTFS received signal, the OTFS received signal corresponding to the OTFS transmitted signal having been reflected by the at least one target, and processing circuitry configured to calculate a first spectrum matrix in a delay-Doppler domain based on the OTFS transmitted signal and the OTFS received signal, and estimate a first distance to the at least one target and a first velocity of the at least one target based on a plurality of first elements included in the first spectrum matrix, the plurality of first elements respectively corresponding to at least some of a first plurality of grids configured to divide uniformly a total search region, and the total search region corresponding to a bandwidth and a frame time of the OTFS transmitted signal in the delay-Doppler domain.

According to an aspect of the inventive concepts, there is provided a method of operating a sensing apparatus including transmitting an orthogonal time frequency space (OTFS) transmitted signal to at least one target, receiving an OTFS received signal, the OTFS received signal corresponding to the OTFS transmitted signal having been reflected by the at least one target, selecting a search mode to obtain a selected search mode, calculating a first spectrum matrix in a delay-Doppler domain corresponding to a search region based on the OTFS transmitted signal, the OTFS received signal, a search region and a search precision, the search region and the search precision corresponding to the selected search mode, and estimating a first distance to the at least one target and a first velocity of the at least one target based on a plurality of first elements included in the first spectrum matrix, the search region including a first plurality of grids, the first plurality of grids being uniform, and the plurality of first elements respectively corresponding to the first plurality of grids.

According to an aspect of the inventive concepts, there is provided a sensing apparatus including a transmitting/receiving circuit configured to transmit an orthogonal time frequency space (OTFS) transmitted signal to at least one target, and receive an OTFS received signal, the OTFS received signal corresponding the OTFS transmitted signal having been reflected by the at least one target, and processing circuitry configured to calculate a first spectrum matrix in a delay-Doppler domain based on the OTFS transmitted signal and the OTFS received signal, and estimate a first distance to the at least one target and a first velocity of the at least one target based on a plurality of first elements included in the first spectrum matrix, a number of symbols allocated to the OTFS transmitted signal being M, a number of sub-carriers allocated to the OTFS transmitted signal being N, a total search region corresponding to a bandwidth and a frame time of the OTFS transmitted signal in the delay-Doppler domain including MN×MN grids, the MN×MN grids being uniform, and a number of the plurality of first elements is equal to or less than MN×MN.

### BRIEF DESCRIPTION OF THE DRAWINGS

Embodiments of the inventive concepts will be more clearly understood from the following detailed description taken in conjunction with the accompanying drawings in which:

FIG. 1 is a block diagram of a sensing apparatus according to embodiments;

FIG. 2 is a block diagram of a sensing apparatus according to embodiments;

FIG. 3 is a block diagram of a transmitting/receiving circuit and a target estimation circuit according to embodiments;

FIG. 4 is a block diagram of a target estimation circuit according to embodiments;

FIG. 5 is a diagram of a search region in a total search mode according to embodiments;

FIG. 6 is a diagram illustrating a spectrum corresponding to a spectrum matrix in a total search mode according to embodiments;

FIG. 7 is a block diagram of a target estimation circuit according to embodiments;

FIG. 8 is a diagram of a search region in a partial search mode according to embodiments;

FIGS. 9A and 9B are diagrams illustrating spectra corresponding to spectrum matrices in a partial search mode, according to embodiments;

FIG. 10 is a block diagram of a target estimation circuit according to embodiments;

FIG. 11 is a diagram of a search region in a detail search mode according to embodiments;

FIGS. 12A and 12B are diagrams illustrating spectra corresponding to spectrum matrices in the detail search mode, according to embodiments;

FIG. 13 is a block diagram of a sensing apparatus according to embodiments;

FIG. 14 is a diagram for explaining a change of a search region according to embodiments;

FIG. 15 is a flowchart of an operation of a sensing apparatus according to embodiments;

FIG. 16 is a flowchart of an operation of a sensing apparatus for determining a search mode, according to embodiments;

FIG. 17 is a flowchart of an operation of a sensing apparatus for determining a search mode, according to embodiments;

FIG. 18 is a flowchart of an operation of a sensing apparatus for target tracing in a search mode, according to embodiments; and

FIG. 19 is a diagram of a vehicle system configured to perform a target search operation according to embodiments.

### DETAILED DESCRIPTION

Hereinafter, embodiments of the inventive concepts will be described in detail with reference to the accompanying drawings.

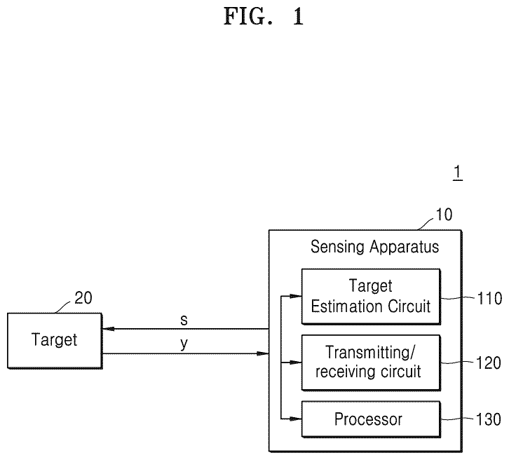

FIG. 1 is a block diagram of a sensing system 1 according to embodiments.

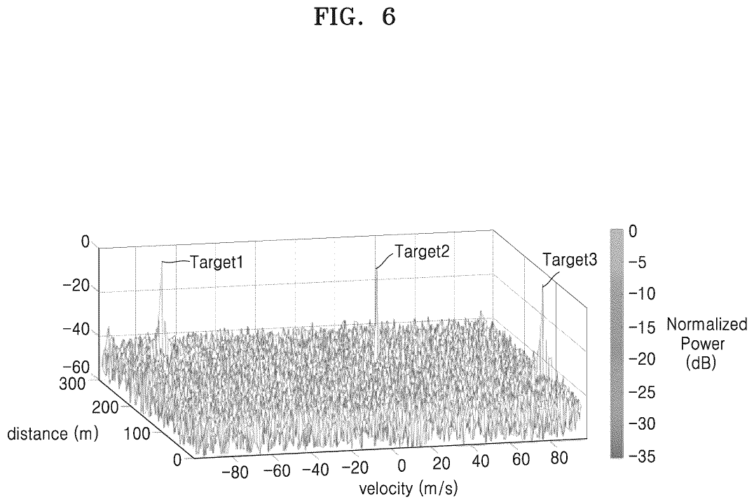

Referring to FIG. 1, the sensing system 1 may include a sensing apparatus 10 and/or a target 20. In the inventive concepts, the target 20 may be referred to as an object to be sensed by the sensing apparatus 10. Although only one target 20 is illustrated in FIG. 1, this is for convenience of explanation, and the sensing system 1 and the sensing apparatus 10 according to the inventive concepts may sense at least one target as described below with reference to FIG. 6 and thereafter. The sensing system 1 according to the inventive concepts may include an integrated sensing and communication (ISAC) system. Accordingly, the sensing apparatus 10 may transceive data, perform information exchange, and at the same time (or contemporaneously), sense the target. The ISAC system may include a system in which a communication system for data transmission/reception and a radar system for sensing a target are designed to operate simultaneously (or contemporaneously) in the same frequency band (or similar frequency bands), and may be referred to as a “joint radio-communication system”, a “joint communication-radar system”, a “dual function radio and communication system”, a “communication-radar coexistence system”, etc.

Although a method of sensing a target based on an orthogonal time frequency space (OTFS) signal by using the sensing system 1 and the sensing apparatus 10 in the inventive concepts is mainly described, it should be noted that the sensing system 1 and the sensing apparatus 10 according to the inventive concepts may also perform transmission/reception of data together with the sensing the target as described above.

In the inventive concepts, the OTFS signal may mean a signal modulated according to an OTFS method. Unlike the orthogonal frequency division multiplexing (OFDM) method, in which signals are modulated in the frequency domain, the OTFS method may include a method of modulating signals in a delay-Doppler domain. The OTFS signal modulated in the delay-Doppler domain may effectively handle signal distortion phenomenon caused by the multipath and the Doppler elements that may occur during the movement of symbols. Accordingly, when the target is sensed based on the OTFS signal, because the influence of inter-carrier interference (ICI) and inter-symbol interference (ISI) may be less than those of the case when signals based on the OFDM method are used, target sensing performance may be improved. In particular, when the target is sensed based on the OTFS signal, the sensing performance may be improved in the multiple path environment, and the sensing performance may be improved in a highly mobile environment (for example, an environment in which the sensing apparatus 10 moves at a higher speed and/or an environment in which the target moves at a higher speed). However, because the delay-Doppler domain corresponds to a two-dimensional domain, when the target is sensed by using the OTFS signal, modulation and target estimation in the two-dimensional domain may be performed, and thus the complexity of computation for the target sensing may be higher.

The sensing system 1 and the sensing apparatus 10 according to the inventive concepts may reduce the complexity of computation for the target sensing, by dividing the delay-Doppler domain into uniform grids based on the number of symbols and the number of the subcarriers allocated to the OTFS signal, calculating a spectrum matrix corresponding to the uniform grids, and sensing the target.

The sensing system 1 and the sensing apparatus 10 according to the inventive concepts may operate in different search modes according to the sensing environment, and may sense the target by varying the search region and/or search precision according to the search mode. Accordingly, the sensing system 1 and the sensing apparatus 10 according to the inventive concepts may sense a target by adaptively adjusting the complexity of the computation according to the sensing environment.

Referring to FIG. 1, the sensing apparatus 10 may include a target estimation circuit 110, a transmitting/receiving circuit 120, and/or a processor 130. In addition, although not illustrated in FIG. 1, the sensing apparatus 10 may include a plurality of antennas for transmitting and/or receiving the OTFS signals.

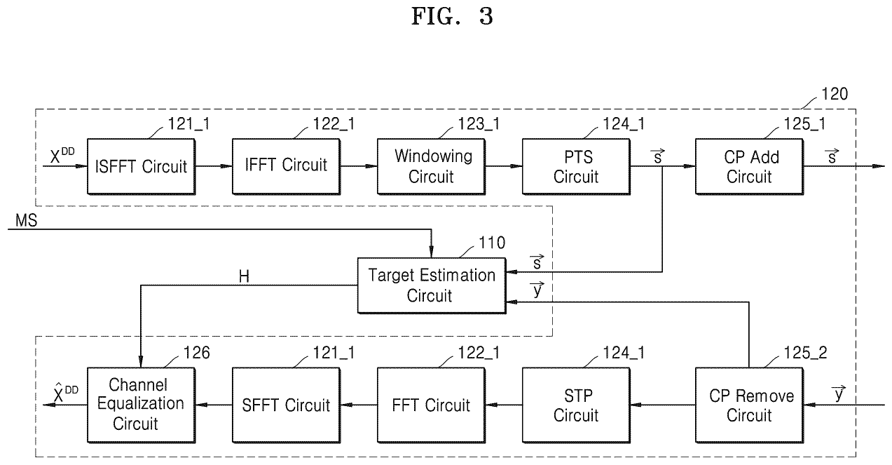

The transmitting/receiving circuit 120 according to the inventive concepts may transceiver (e.g., transmit and/or receive) the OTFS signal via at least one of the plurality of antennas. At least some of the plurality of antennas may correspond to transmitting antennas, and the remaining may correspond to receiving antennas. The transmitting/receiving circuit 120 may generate the OTFS signal based on an OTFS modulation method, and may transmit the OTFS signal via the transmitting antenna. In the inventive concepts, the OTFS signal transmitted by the sensing apparatus 10 may be referred to as an OTFS transmitted signal s. The sensing apparatus 10 may transmit the OTFS transmitted signal s for sensing the target 20, and the OTFS transmitted signal s may be reflected by the target 20. The transmitting/receiving circuit 120 included in the sensing apparatus 10 may receive the OTFS transmitted signal s reflected by the receiving antenna. In the inventive concepts, a signal received by the sensing apparatus 10 may be referred to as an OTFS received signal y. In other words, the OTFS received signal y may mean a signal in which the OTFS transmitted signal s has been reflected by the target 20 and returned to the sensing apparatus 10. Each of the OTFS transmitted signal s and the OTFS received signal y is described in more detail with reference to FIG. 3.

The target estimation circuit 110 according to the inventive concepts may estimate a distance to the target 20 and a velocity of the target 20 based on the OTFS transmitted signal s and the OTFS received signal y. In the inventive concepts, for convenience of description, estimation of the distance to the target 20 and the velocity of the target 20 (for example, perhaps, a relative speed) may be referred to as estimation of the target 20. The OTFS received signal y may be different from the OTFS transmitted signal s, depending on the distance between the sensing apparatus 10 and the target 20 and the velocity of the target 20 (e.g., relative to the sensing apparatus 10). For example, the OTFS received signal y may include a Doppler element and a delay element based on the distance between the sensing apparatus 10 and the target 20 and the velocity of the target 20, and as a result, the OTFS received signal y may be different from the OTFS transmitted signal s. The target estimation circuit 110 may estimate the target 20 based on the difference between the OTFS received signal y and the OTFS transmitted signal s.

The processor 130 may control the entire operation of the sensing apparatus 10, and for example, the processor 130 may include a central processing unit (CPU). The processor 130 may include one processor core (or single core) or a plurality of processor cores (or multi-core). However, the processor 130 according to the inventive concepts is not limited thereto.

The processor 130 according to the inventive concepts may adaptively determine a search mode according to the sensing environment. The processor 130 according to embodiments may determine the search mode based on whether the search is an initial search. The processor 130 according to embodiments may determine the search mode based on whether at least one of the velocity of the target 20 and the distance to the target 20 is greater than a predetermined (or alternatively, given) threshold value. The processor 130 according to embodiments may determine the search region for estimating the target 20 after one frame time based on an estimation result of the target 20. Detailed description on this issue is given below.

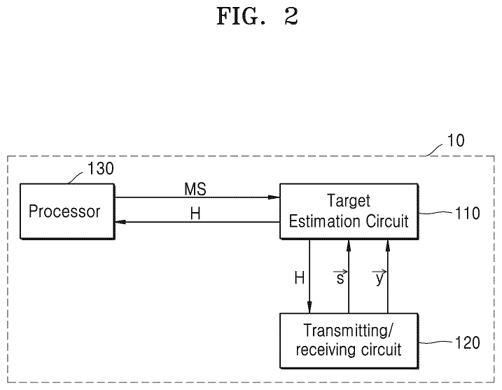

The target estimation circuit 110, the transmitting/receiving circuit 120, and/or the processor 130 included in the sensing apparatus 10 according to the inventive concepts may be configured in a single chip. In addition, the target estimation circuit 110 and the processor 130 are illustrated in FIG. 1 as separate elements, but this is for convenience of explanation, and the target estimation circuit 110 according to the inventive concepts may also be included in the processor 130. In addition, the sensing apparatus 10 according to the inventive concepts may further include various elements other than those elements illustrated in FIG. 1. For example, the sensing apparatus 10 according to the inventive concepts may further include a memory, and the memory may store a threshold value according to the inventive concepts, etc. FIG. 2 is a block diagram of the sensing apparatus 10 according to embodiments.

The sensing apparatus 10 according to the inventive concepts may include the target estimation circuit 110, the transmitting/receiving circuit 120, and the processor 130 as described above with reference to FIG. 1.

The transmitting/receiving circuit 120 may output an OTFS transmission symbol vector \vec{s} and an OTFS reception symbol vector \vec{y} to the target estimation circuit 110. The transmitting/receiving circuit 120 may generate the OTFS transmitted signal s described above with reference to FIG. 1 based on the OTFS transmission symbol vector \vec{s}, and may generate the OTFS reception symbol vector \vec{y} based on the OTFS received signal y described above with reference to FIG. 1. Detailed description on this is given below with reference to FIG. 3.

Referring to the description given above, the OTFS transmission symbol vector \vec{s} may correspond to the OTFS transmitted signal s, and the OTFS reception symbol vector \vec{y} may correspond to the OTFS received signal y. In addition, as described above with reference to FIG. 1, the OTFS received signal y may be different from the OTFS transmitted signal s due to the Doppler element and the delay element. Thus, the difference between the OTFS transmission symbol vector \vec{s} and the OTFS reception symbol vector \vec{y} may be due to the Doppler element and the delay element.

The target estimation circuit 110 according to the inventive concepts may calculate a spectrum matrix H based on the OTFS transmission symbol vector \vec{s} and the OTFS reception symbol vector \vec{y}. The target estimation circuit 110 may calculate the spectrum matrix H for the search region based on a correlation between the OTFS transmission symbol vector \vec{s} and the OTFS reception symbol vector \vec{y}, and the sensing apparatus 10 may estimate the target by using the calculated spectrum matrix H. Each of the plurality of elements included in the spectrum matrix H according to the inventive concepts may correspond to a correlation value between the OTFS transmission symbol vector \vec{s} and the OTFS reception symbol vector \vec{y}, and the correlation value corresponding to each of the plurality of elements may vary depending on the degree of compensation for the Doppler element and the delay element included in the OTFS reception symbol vector \vec{y}. For example, when compensation for the Doppler element and the delay element included in the OTFS reception symbol vector \vec{y} is properly performed, the correlation value between the OTFS reception symbol vector \vec{y} and the OTFS transmission symbol vector \vec{s} may be relatively large, and the corresponding element may have a larger value than other elements included in the spectrum matrix H. Accordingly, the target estimation circuit 110 may estimate the target based on an element having a relatively large value among elements included in the spectrum matrix H. For example, the target estimation circuit 110 may estimate the target based on the degree of compensation for the Doppler element and the delay element corresponding to the element having a relatively large value among the elements included in the spectrum matrix H. The sensing apparatus 10 according to the inventive concepts may infer information about a relative position, a movement direction, and the like of the target by estimating the target 20, and as a result, may determine whether the sensing apparatus 10 collides with the target 20.

Referring to FIG. 2, the target estimation circuit 110 may output the spectrum matrix H to the transmitting/receiving circuit 120. The transmitting/receiving circuit 120 may demodulate the OTFS received signal (y in FIG. 1) based on the spectrum matrix H.

The processor 130 according to the inventive concepts may output a mode signal MS to the target estimation circuit 110. The processor 130 may determine an appropriate search mode according to the sensing environment, and may output the mode signal MS corresponding to the determined search mode to the target estimation circuit 110. The target estimation circuit 110 may receive the mode signal MS, and perform the target sensing according to a mode indicated by the mode signal MS. The target estimation circuit 110 according to the inventive concepts may operate in any one of the total search mode, the partial search mode, and/or the detail search mode according to the mode signal MS. In the inventive concepts, the search region and the spectrum matrix corresponding to the total search mode may be referred to as an total search region and a total spectrum matrix, respectively, a partial region and the spectrum matrix corresponding to the partial search mode may be referred to as a partial search region and a partial spectrum matrix, respectively, and the search region and the spectrum matrix corresponding to the detail search mode may be referred to as a detail search region and a detail spectrum matrix, respectively.

FIG. 3 is a block diagram of the transmitting/receiving circuit 120 and the target estimation circuit 110 according to embodiments.

Referring to FIG. 3, the transmitting/receiving circuit 120 may include an inverse symplectic finite Fourier transform (ISFFT) circuit 121_1, an inverse finite Fourier transform (IFFT) circuit 122_1, a windowing circuit 123_1, a parallel to serial (PTS) circuit 124_1, a cyclic prefix (CP) addition circuit 125_1, a CP removal circuit 125_2, a serial to parallel (STP) circuit 124_2, a finite Fourier transform (FFT) circuit 122_2, a symplectic finite Fourier transform (SFFT) circuit 121_2, and/or a channel equalization circuit 126. As described above with reference to FIG. 2, the target estimation circuit 110 may receive the OTFS transmission symbol vector \vec{s} and the OTFS reception symbol vector \vec{y} from the transmitting/receiving circuit 120, and may calculate the spectrum matrix H based on the OTFS transmission symbol vector \vec{s} and the OTFS reception symbol vector \vec{y}. In addition, the mode signal MS may be received from the processor 130, and the spectrum matrix H may be output to the transmitting/receiving circuit 120.

Referring to FIG. 3, X^{DD} may mean a data symbol defined in the delay-Doppler domain. The ISFFT circuit 121_1 may perform the FFT in a column direction and the IFFT in a row direction on X^{DD}, which is expressed in Formula 1 below.

$$X = {F}_{N} {X}^{DD} {F}_{M}^{H} \qquad [ Formula 1 ]$$

In Formula 1, Fₐ may indicate a discrete Fourier transform (DFT) matrix having a size of a×a, where the a is a natural number, N may indicate the number of sub-carriers, and M may indicate the number of symbols.

The IFFT circuit 122_1 may perform the IFFT or Heisenberg transform on X to convert the signal into the time domain. To prevent the signal from being interfered with other frequency bands (or reduce the amount of interference), the windowing circuit 123_1 may apply a window function having a value of 1 in the interval of 0≤t≤1 and a value of 0 in other intervals, and the PTS circuit 124_1 may serialize the signals to which the window function is applied. The CP adding circuit 125_1 may add the CP to the signal for each frame. Although omitted in FIG. 3, the transmitting/receiving circuit 120 may further include a digital-to-analog converter (DAC), and the DAC may generate the OTFS transmitted signal (s in FIG. 1) by analog-converting the OTFS transmission symbol vector \vec{s}. The OTFS transmitted signal (s in FIG. 1) may be expressed as Formula 2 below.

$$s ( t ) = rect ( \frac{t}{MT} ) {\sum }_{m = 0}^{M - 1} {s}_{m} ( t - MT ) + rect ( \frac{t + {T}_{cp}}{{T}_{cp}} ) {\sum }_{m = 0}^{M - 1} {s}_{m} ( t + MT - mt ) , \qquad [ Formula 2 ]$$

$$- {T}_{cp} \leq t \leq MT$$

In Formula 2, T_{cp} may mean a CP length, and T_{cp} may be designed to be less than a maximum (or highest) delay of a channel. In addition, T may mean a symbol time. Sₘ(t) may mean a signal of an m-th symbol, and rect(t) may mean a rectangular window function that has a value of 1 for 0≤t≤1 and a value of 0 otherwise.

As described above with reference to FIG. 1, the sensing apparatus 10 according to the inventive concepts may transmit the OTFS transmitted signal s to sense the target, and the OTFS transmitted signal s may be reflected by the target. The transmitting/receiving circuit 120 may receive the OTFS received signal y reflected by the target. The OTFS received signal y may be represented by Formula 3 below.

$$y ( t ) = {\sum }_{k = 0}^{K - 1} {α}_{j} {e}^{{j 2 π v}_{k} t} s ( t - {τ}_{k} ) + z ( t ) \qquad [ Formula 3 ]$$

In Formula 3, K may mean the number of paths, and in the case of the sensing system 1, K may mean the number of targets. In addition, αₖ, ∇ₖ, τₖ may mean a channel gain, Doppler frequency shift (which may be referred to as the Doppler element in the inventive concepts), and delay (which may be referred to as the delay element in the inventive concepts) of the kth target, respectively. In addition, z (t) may mean additive Gaussian noise.

Although omitted in FIG. 3, the transmitting/receiving circuit 120 may further include an analog-to-digital converter (ADC), and the ADC may digital-convert the OTFS received signal y into the OTFS reception symbol vector \vec{y}. The OTFS reception symbol vector \vec{y} may be expressed as Formula 4 below.

$$\vec{y} = y ( t ) {\vert}_{t = lT / N} = {\sum }_{k = 0}^{K - 1} {α}_{k} {D}_{NM} ( {\overline{v}}_{k} ) {F}_{NM}^{H} {D}_{NM} ( - {\overline{τ}}_{k} ) {F}_{NM} \vec{s} + \vec{z} \qquad [ Formula 4 ]$$

In Formula 4, Dₐ(b) may be a diagonal matrix, and an ith element may be e^{j2πib} In addition, 1th samples of s and 2 may mean Cambria Math, respectively, and in addition, τ̅ₖ and ν̅ₖ may mean

$$\frac{{τ}_{k}}{MT} ,$$

$$\frac{T}{N} {v}_{k} ,$$

respectively.

The CP removal circuit 125_2, the STP circuit 124_2, the FFT circuit 122_2, and the SFFT circuit 121_2 illustrated in FIG. 3 may be understood as performing a reverse operation against the operations of the CP addition circuit 125_1, the PTS circuit 124_1, the IFFT circuit 122_1, and the ISFFT circuit 121_1 described above, and thus detailed descriptions thereof are omitted.

Referring to FIG. 3, the target estimation circuit 110 may receive the OTFS transmission symbol vector \vec{s} and the OTFS reception symbol vector \vec{y} from the transmitting/receiving circuit 120, and may calculate the spectrum matrix H based on the OTFS transmission symbol vector \vec{s} and the OTFS reception symbol vector \vec{y}. As described above, because the OTFS signal is modulated in the delay-Doppler domain corresponding to the two-dimensional domain, the complexity of calculating the spectrum matrix H may be higher. The target estimation circuit 110 according to the inventive concepts may calculate the spectrum matrix H by using a relatively low complexity operation as to be described below.

Referring to FIG. 3, the channel equalization circuit 126 may receive the spectrum matrix H. The channel equalization circuit 126 may detect the estimated data symbol \hat{X}^{DD} corresponding to X^{DD} based on the spectrum matrix H.

A plurality of components included in the transmitting/receiving circuit 120 described above are illustrated in FIG. 3 as discrete components independent of each other, but this is only for convenience of description of the OTFS transmission symbol vector \vec{s} and the OTFS reception symbol vector \vec{y}, and the transmitting/receiving circuit 120 according to the inventive concepts is not limited thereto. For example, all or some of the plurality of components included in the transmitting/receiving circuit 120 illustrated in FIG. 3 may be implemented as a single circuit.

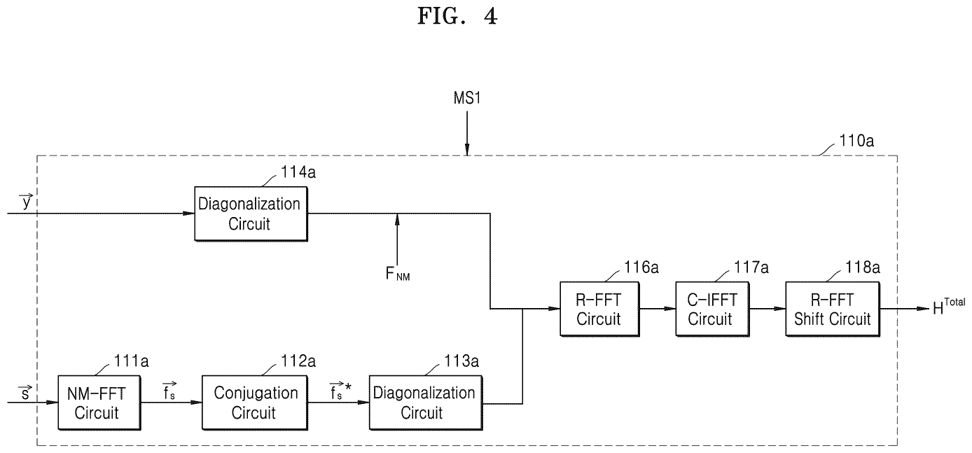

FIG. 4 is a block diagram of a target estimation circuit 110a according to embodiments.

As described above, the target estimation circuit 110a may receive a mode signal determined according to the sensing environment.

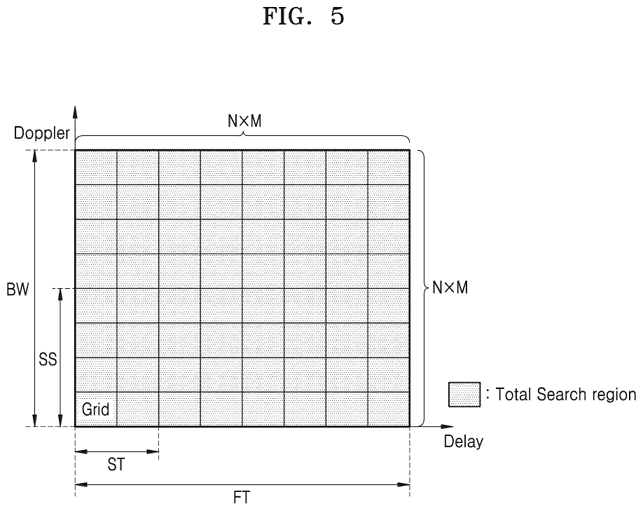

The target estimation circuit 110a illustrated in FIG. 4 may receive a first mode signal MS1, and may operate in the total search mode corresponding to the first mode signal MS1. The total search mode according to the inventive concepts may be referred to as a mode in which a search is performed in the search region (or may be referred to as a total search region) corresponding to a bandwidth and the frame time of the OTFS transmitted signal in the delay-Doppler domain. Because the search region corresponding to the total search mode corresponds to the bandwidth and the frame time of the OTFS transmitted signal, the search region may correspond to the maximum (or largest) region capable of sensing the target by using the OTFS transmitted signal. Accordingly, in the total search mode, the target estimation circuit 110a may calculate a spectrum matrix corresponding to the total range that may be sensed. A search region according to the total search mode is described in more detail with reference to FIG. 5.

In the inventive concepts, performing a search may mean calculating a spectrum matrix corresponding to the search region. Accordingly, as the search region becomes wider, the complexity of the computation for calculating a spectrum matrix may increase. However, in the case of calculating a spectrum matrix according to the total search mode according to the inventive concepts, the complexity of the computation may be reduced by uniformly dividing the search region by the number of sub-carriers and symbols allocated to the OTFS transmitted signal, and calculating a spectrum matrix H^{Total} including elements respectively corresponding to a plurality of grids obtained by the uniform dividing of the search region.

Referring to FIG. 4, the target estimation circuit 110a may include an NM-FFT circuit 111a, a conjugation circuit 112a, two of diagonalization circuits 113a and 114a, a row (R)-FFT R-FFT circuit 116a, a column (C)-IFFT C-IFFT circuit 117a, and/or an R-FFT shift circuit 118a.

The spectrum matrix H^{Total} calculated by the target estimation circuit 110a operating in the total search mode in FIG. 4 may be expressed as Formula 5 below.

$${H}^{Total} = {F}_{NM}^{H} diag ( {\vec{f}}_{s}^{*} ) {F}_{NM} diag ( \vec{y} ) {F}_{NM} {F}_{shift} \qquad [ Formula 5 ]$$

In this case, \vec{f}ₛ=F_{NM}\vec{s}, F_{shift} may mean a FFT shift function, and F_{shift} may be expressed as

$$[ \begin{matrix}{O}_{NM / 2 , NM / 2} & {I}_{NM / 2} \\ {I}_{NM / 2} & {O}_{NM / 2 , NM / s}\end{matrix} ]$$

with respect to an identity matrix Iₙ and a null matrix O_{n,m}. Referring to FIGS. 4 and 5 together, the NM-FFT circuit 111a may generate \vec{fs} by performing the FFT operation on the OTFS transmission symbol vector \vec{s}, and the conjugation circuit 112a may generate \vec{fs}* by performing a conjugation operation on \vec{fs}. The diagonalization circuit 113a may generate diag

$$( {\vec{f}}_{s}^{*} )$$

by performing the diagonalization operation on \vec{fs}, and the diagonalization circuit 114a may generate diag(\vec{y}) by performing the diagonalization operation on the OTFS reception symbol vector \vec{y}. The target estimation circuit (110a) may calculate a product of diag(\vec{y}) and F_{NM}. Each of the R-FFT circuit 116a and C-IFFT circuit 117a may perform, on diag(\vec{fₛ}*)F_{NM} diag(\vec{y}), the FFT operation in the row direction, and the IFFT operation in the column direction. The R-FFT shift circuit 118a may perform the FFT shift operation on the input in the row direction.

FIG. 5 is a diagram of a search region in a total search mode according to embodiments.

FIG. 5 is a diagram illustrating a search region according to the total search mode described above with reference to FIG. 4.

Referring to FIG. 5, in the delay-Doppler domain, the area of the search region according to the total search mode may be determined by a frame time FT and a bandwidth BW of the OTFS transmitted signal. Accordingly, the search region according to the total search mode may correspond to a total region that the sensing apparatus (10 in FIG. 1) may sense. For example, referring to FIG. 5, the frame time FT may include four of the symbol times ST, and the bandwidth BW may include two of sub-carrier spacings SS. This configuration may mean that four of the symbol times ST and two of the sub-carriers are allocated to the OTFS transmitted signal.

The search region according to the total search mode according to the inventive concepts may be divided into uniform grids based on the number M of symbols and the number N of sub-carriers allocated to the OTFS transmitted signal. For example, referring to FIG. 5, when a symbol allocated to the OTFS transmitted signal is 4, that is, (M=4) and the sub-carrier allocated thereto is 2, that is, (N=2), the search region according to the total search mode may be divided into 64 uniform grids.

A target estimation circuit according to the inventive concepts may calculate the spectrum matrix (H^{Total} in FIG. 4) including elements respectively corresponding to the plurality of uniformly grids in the total search mode. For example, referring to FIG. 5, because the search region is divided into uniform 64 grids in the total search mode, the calculated spectrum matrix (H^{Total} in FIG. 4) may include 64 elements respectively corresponding to the 64 uniform grids. As described above, the sensing apparatus 10 according to the inventive concepts may determine elements having relatively large values among the elements included in the spectrum matrix (H^{Total} in FIG. 4), and may estimate the number of sensed targets, distance to the targets, and velocities of the targets based on the number of the determined elements and coordinates of the elements. According to embodiments of the inventive concepts, a sensing apparatus may estimate a target based on the number of elements having a value equal to or greater than a certain threshold value and coordinates of the elements.

FIG. 5 and the example described above with reference to FIG. 5 are only for describing a search region according to the inventive concepts, and the search region according to the inventive concepts are not limited thereto. As described above, the search region according to the inventive concepts may vary according to the bandwidth BW and frame time FT of the OTFS transmitted signal, and the number of uniform grids included in the search region may also vary based on the number M of symbols and the number N of sub-carriers allocated to the OTFS transmitted signal.

FIG. 6 is a diagram illustrating a spectrum corresponding to a spectrum matrix in the total search mode according to embodiments.

FIG. 6 is a diagram of a spectrum corresponding to the spectrum matrix (H^{Total} in FIG. 4) calculated in the total search mode described above with reference to FIGS. 4 and 5. Referring to FIG. 6, the spectrum may include three peak-points having values greater than the surrounding values. In this case, the peak-point may correspond to an element having a relatively larger value among the elements included in the spectrum matrix. Accordingly, referring to FIG. 6, the sensing apparatus 10 may sense a first target Target 1, a second target Target 2, and a third target Target 3 in the search region according to the total search mode. In addition, from the coordinates of each of the first target Target 1, the second target Target 2, and the third target Target 3 in the delay-Doppler domain, the sensing apparatus 10 may estimate that the first target Target 1 is moving at a velocity of about-76 m/s at a distance of about 244 m from the sensing apparatus 10, that the second target Target 2 is moving at a velocity of about 23 m/s at a distance of about 187 m from the sensing apparatus 10, and that the third target Target 3 is moving at a velocity of about 90 m/s at a distance of about 94 m from the sensing apparatus 10. In this case, the negative sign of the velocity may mean that a target is moving in a direction toward the sensing apparatus 10.

The descriptions given above with reference to FIG. 6 are examples for describing the inventive concepts, and the inventive concepts are not limited thereto. For example, the search region according to the inventive concepts may be different from that illustrated in FIG. 6, and the number of targets searched from the search region and the coordinates of the targets may be different.

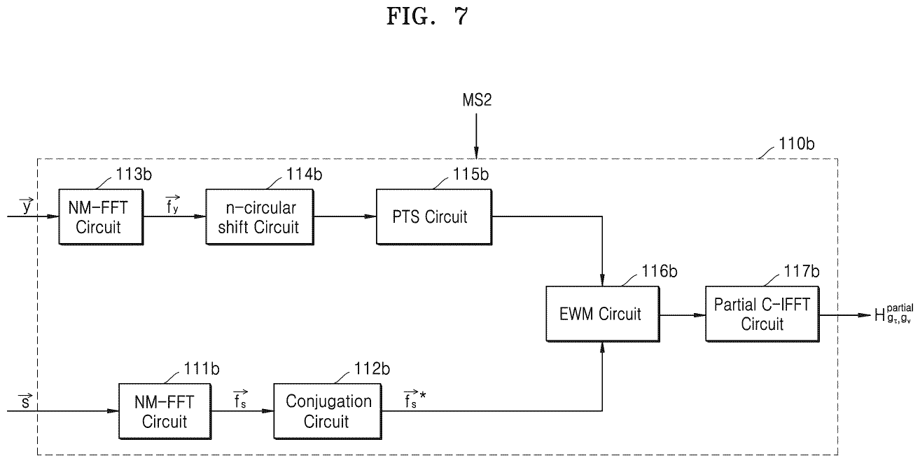

FIG. 7 is a block diagram of a target estimation circuit 110b according to embodiments.

As described above, the target estimation circuit 110b may receive a mode signal determined according to the sensing environment.

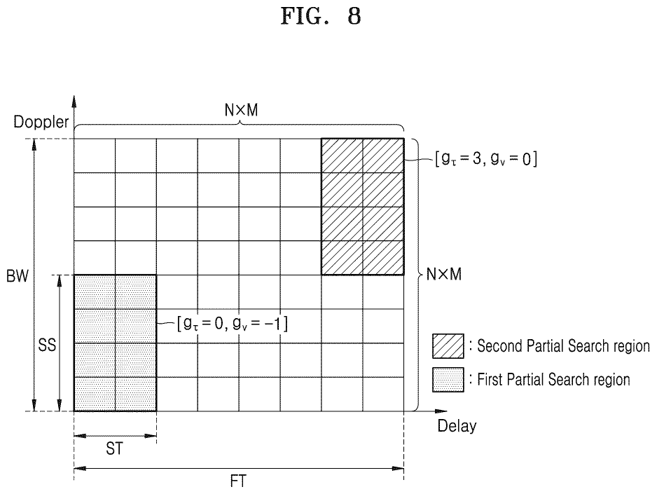

The target estimation circuit 110b illustrated in FIG. 7 may receive a second mode signal MS2 and may operate in the partial search mode corresponding to the second mode signal MS2. The partial search mode according to the inventive concepts may be referred to as a mode in which a search is performed for a partial region (e.g., only a partial region) of the total region (for example, a search region according to the total search mode described above) corresponding to the bandwidth and the frame time of the OTFS transmitted signal in the delay-Doppler domain. The search region corresponding to the partial search mode may correspond to the length of the symbol (that is, the symbol time ST) allocated to the OTFS transmitted signal and the sub-carrier spacing. Accordingly, in the partial search mode, the target estimation circuit 110b may calculate a spectrum matrix corresponding to a partial range among the total range that may be sensed. The search region according to the partial search mode is described in more detail with reference to FIG. 8 below.

Referring to FIG. 7, the target estimation circuit 110b according to embodiments of the inventive concepts may include two of NM-FFT circuits 111b and 113b, a conjugation circuit 112b, an n-circular shift circuit 114b, a PTS circuit 115b, an element-wise multiplication (EWM) circuit 116b, and/or a partial C-IFFT circuit 117b. Operation of each of the two of NM-FFT circuits 111b and 113b, the conjugation circuit 112b, and the PTS circuit 115b may be understood with reference to descriptions given above and Formula 6 to be described below, and thus detailed descriptions thereof are omitted. Referring to FIG. 6, the input of the n-circular shift circuit 114b may include a vector, and the n-circular shift circuit 114b may perform an operation of circular shifting the vector elements one by one. An EWM circuit 116b may perform the element-wise multiplication operation of a matrix, and the partial C-IFFT circuit 117b may perform the IFFT operation only for some of the total vectors in the column direction. By performing, by the partial C-IFFT circuit 117b, the IFFT operation only on a portion of the total vector in the column direction, the complexity of computation may be reduced compared to performing the IFFT operation on the total vector.

The spectrum matrix

$${H}_{{g}_{τ} , {g}_{v}}^{Partial}$$

calculated by the target estimation circuit 110b operating in the partial search mode in FIG. 7 may be expressed as Formula 6 below. Formula 6 may be understood with reference to descriptions of components included in FIG. 7 and the target estimation circuit 110b.

$${H}_{{g}_{τ} , {g}_{v}}^{Partial} [ : , l ] = {F}_{NM}^{H} [ {g}_{τ} N : {g}_{τ} ( N + 1 ) - 1 , : ] ( {\vec{{f}_{s}}}^{*} ⊙ ( {F}_{NM} {D}_{NM} ( - {\overline{v}}_{l}^{Partial} ) \vec{y} ) \qquad [ Formula 6 ]$$

In Formula 6, each of g_{τ} and g_{ν} may be an index indicating the position of the search region according to the partial search mode, and correspond to

$$0 \leq {g}_{τ} \leq M - 1 ,$$

$$- \frac{N}{2} \leq {g}_{v} \leq \frac{N}{2} - 1.$$

Referring to Formula 6 and the descriptions given above together, according to a value of l, F_{NM}D_{NM}(−\vec{ν}ₗ⁽²⁾)\vec{y} may be calculated as a value circular shifted from F_{NM}\vec{y} to l+g_{ν}M. For each of l=0, 1 . . . . M−1, the product between elements of

$${F}_{NM} {D}_{NM} ( - {\overline{v}}_{l}^{Partial} ) \vec{y}$$

$$and$$

$${\vec{f}}_{s}^{*}$$

(expressed as ⊙ in Formula 6) calculated by using the process described above may be performed, and g_{τ} th IFFT may be performed for each column. In Formula 6,

$$( {\overline{τ}}_{i}^{Partial} , {\overline{v}}_{l}^{Partial} )$$

may mean a guru for a Doppler axis of the search region according to the partial search mode, and

$${\overline{v}}_{l}^{Partial}$$

that is a grid of the search region according to the partial search mode may be expressed as Formula 7 below. Formula 7 may be understood with reference to the descriptions given above, and thus detailed descriptions thereof are omitted.

$$( {\overline{τ}}_{i}^{Partial} , {\overline{v}}_{l}^{Partial} ) = ( \frac{i + {g}_{τ} N}{NM} , \frac{l + {g}_{τ} N}{NM} ) , \qquad [ Formula 7 ]$$

$$0 \leq i \leq N - 1 ,$$

$$0 \leq l \leq M - 1$$

Because the range of the Doppler elements and the delay elements determined by system parameters (for example, carrier frequency, a bandwidth, the number of bus carriers, the number of symbols, sub-carrier spacing, the length of CP, or the like) will generally be less than the total search region, it may not be necessary to calculate a spectrum matrix for the total search region. Thus, the sensing apparatus 10 according to the inventive concepts may reduce the complexity by calculating the spectral matrix

$${H}_{{g}_{τ} , {g}_{v}}^{Partial}$$

only for a partial search region according to the partial search mode, as described above with reference to FIG. 7.

FIG. 8 is a diagram of a search region in the partial search mode according to embodiments.

FIG. 8 is a diagram of a search region according to the partial search mode described above with reference to FIG. 7.

Referring to FIGS. 5 and 8, the area of each of the plurality of grids included in the search region according to the partial search mode may be the same as (or similar to) each of the plurality of grids included in the search region according to the total search mode. Referring to FIG. 8, in the delay-Doppler domain, the area of the search region according to the partial search mode may be determined by the symbol time ST and the sub-carrier spacing SS allocated to the OTFS transmitted signal. For example, as described above with reference to FIG. 5, when a symbol allocated to the OTFS transmitted signal is 4, that is, (M=4) and the sub-carrier allocated thereto is 2, that is, (N=2), the total search region may be divided into 64 uniform grids. In this case, referring to the description given above of Formula 6 described above, it may be understood that because

$$0 \leq {g}_{τ} \leq M - 1 , - \frac{N}{2} \leq {g}_{v} \leq \frac{N}{2} - 1 ,$$

and M=4 and N=2, the range of g_{τ} may be 0≤g_{τ}≤3 and the range of g_{ν} may be −1≤g_{ν}≤0. Referring to FIG. 8, when g_{τ}=0 and g_{ν}=−1, the search region according to the partial search mode may include a first search region, and when g_{τ}=3 and g_{ν}=0, the search region according to the partial search region may include a second search region.

As described above, the sensing apparatus 10 according to the inventive concepts may estimate the target, by not calculating a spectrum matrix corresponding to the total search region but calculating the spectrum matrix

$${H}_{{g}_{τ} , {g}_{v}}^{Partial}$$

in FIG. 7 for a partial region corresponding to the symbol time ST and the sub-carrier spacing SS allocated to the OTFS transmitted signal in the total region divided into uniform grids. In addition, as described above, the search region according to the partial search mode may be adaptively changed, by adjusting the indices (g_{τ} and g_{ν}) that indicate the positions of the search region according to the partial search mode.

FIG. 8 and the example described above with reference to FIG. 8 may be only for describing the search region according to the inventive concepts, and thus the search region according to the inventive concepts is not limited thereto. As described above, the search region according to the inventive concepts may vary according to the bandwidth BW and frame time FT of the OTFS transmitted signal, and the number of uniform grids included in the search region may also vary based on the number of symbols M and the number N of sub-carriers allocated to the OTFS transmitted signal.

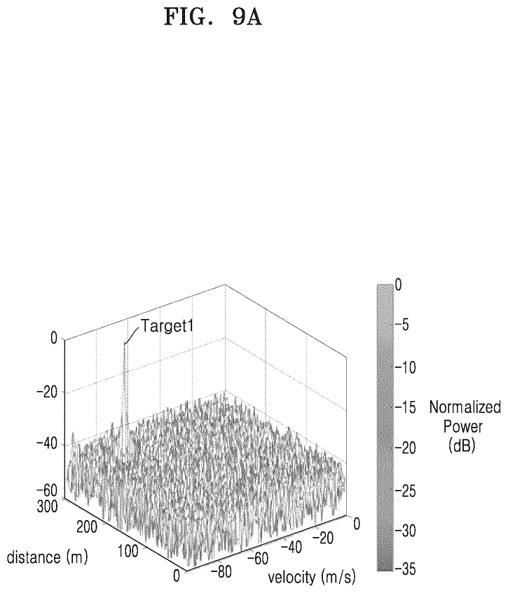

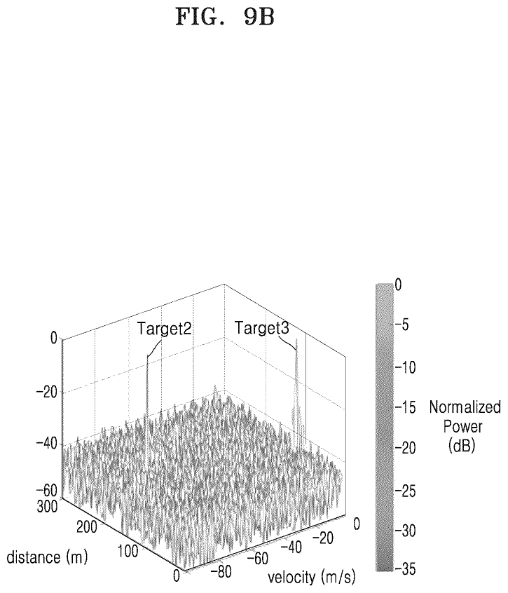

FIGS. 9A and 9B are diagrams illustrating spectra corresponding to spectrum matrices in the partial search mode, according to embodiments.

FIGS. 9A and 9B are diagrams of spectra corresponding to the spectrum matrix

$$( {H}_{{g}_{τ} , {g}_{v}}^{Partial}$$

in FIG. 7) calculated in the partial search mode described above with reference to FIGS. 7 and 8, respectively. The spectra illustrated in FIGS. 9A and 9B may be understood with reference to the spectrum illustrated in FIG. 6. FIGS. 9A, 9B, and 6 illustrate the same sensing results for the same targets (or similar sensing results for similar targets), but the spectra of FIGS. 9A and 9B may be respective spectra according to the partial search mode, and the spectrum of FIG. 6 may be a spectrum according to the total search mode. Referring to FIGS. 9A and 9B, as described above with reference to FIG. 8, the spectrum of FIG. 9A may correspond to the search regions corresponding to g_{τ}=0 and g_{ν}=−1 in the partial search mode, and the spectrum of FIG. 9B may correspond to the search regions corresponding to g_{τ}=0 and g_{ν}=0 in the partial search mode.

Accordingly, as described above, when the sensing apparatus 10 according to the inventive concepts operates in the partial search mode, the target may be sensed by calculating a spectrum matrix for only a portion of the total search region determined by the OTFS transmitted signal. The complexity in estimating the target may be reduced by calculating a spectrum matrix for only a portion of the search region.

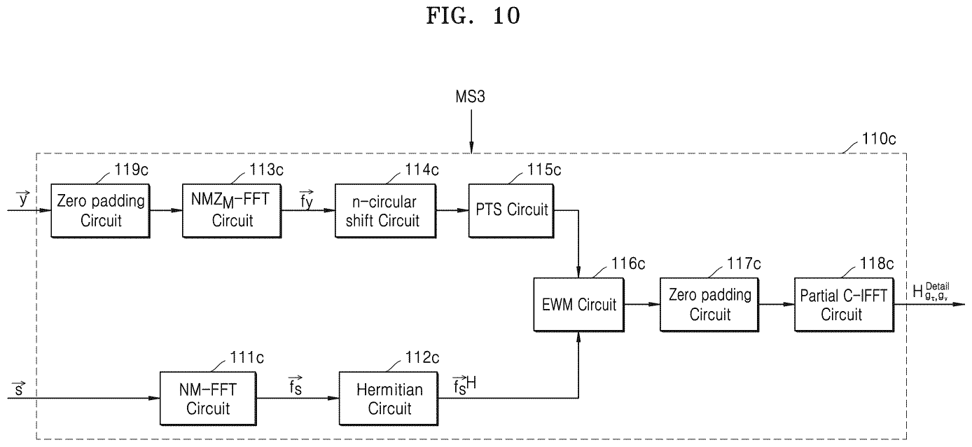

FIG. 10 is a block diagram of a target estimation circuit 110c according to embodiments.

As described above, the target estimation circuit 110c may receive a mode signal determined according to the sensing environment.

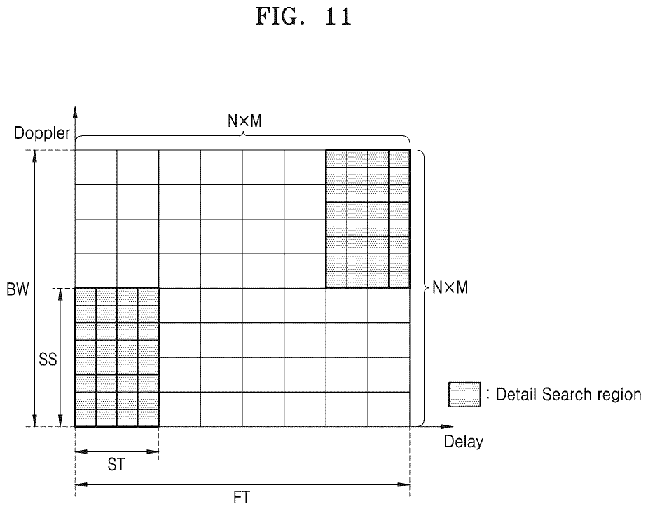

The target estimation circuit 110c illustrated in FIG. 10 may receive a third mode signal MS3, and may operate in the detail search mode corresponding to the third mode signal MS3. The area of a search region according to the detail search mode according to the inventive concepts (which may be referred to as a detail search region in the inventive concepts) may be the same as (or similar to) the area of a search region according to the partial search mode described above. However, the detail search region may include more grids than the partial search region. Accordingly, in the detail search mode, the target estimation circuit 110c may sense the target more accurately than when sensing the target in the partial search mode. The search region according to the detail search mode is described in more detail with reference to FIG. 11 below.

Descriptions of duplicate components included in the target estimation circuit (110a of FIG. 4) and the target estimation circuit (110b of FIG. 7) among the components included in the target estimation circuit 110c are omitted. Referring to FIG. 10, the target estimation circuit 110c according to embodiments of the inventive concepts may include two of zero padding circuits 117c and 119c, an NM-FFT circuit 111c, a Hermitian circuit 112c, an NMZM-FFT circuit 113c, an n-circular shift circuit 114c, a PTS circuit 115c, a EWM circuit 116c, and a partial C-IFFT circuit 118c. In FIG. 10, the size of the OTFS reception symbol vector \vec{y} may be N×M. The zero padding circuit 119c may perform a zero padding operation on the OTFS reception symbol vector \vec{y} so that the size of the OTFS reception symbol vector \vec{y} becomes N×M×Z_{M}. The zero padding circuit 117c may perform the zero padding operation on the received vector so that the size of the received vector becomes N×M×Z_{N}.

The area of a detail search region according to the inventive concepts may be the same as (or similar to) the area of a partial search region, but the number of grids included in the detail search region may be greater than the number of grids included in the partial search region. The number of elements included in a spectrum matrix calculated according to the detail search mode may be greater than the number of elements included in a spectrum matrix calculated according to the partial search mode. Accordingly, a sensing apparatus according to embodiments of the inventive concepts may perform more precise target estimation when operating in the detail search mode than when operating in the partial search mode.

A spectrum matrix

$${H}_{{g}_{τ} , {g}_{v}}^{Detail}$$

that is calculated by the target estimation circuit 110c operating in the detail spectrum matrix in FIG. 10 may be expressed as Formula 8 below. Formula 8 may be understood with reference to descriptions of components included in FIG. 10 and the target estimation circuit 110c.

$${H}_{{g}_{τ} , {g}_{v}}^{Detail} [ : , l ] = {F}_{{NZ}_{N} M}^{H} [ {g}_{τ} {NZ}_{N} : {g}_{τ} ( N + 1 ) {Z}_{N} - 1 : , 0 : NM - 1 ] ( {\vec{f}}_{s}^{*} ⊙ ( {F}_{NM} {D}_{NM} ( - {\overline{v}}_{l}^{Detail} ) \vec{y} ) \qquad [ Formula 8 ]$$

In Formula 8, Z_{N} and Z_{M} may mean a delay for the search region according to the detail search mode and an oversampling factor in the Doppler axis, respectively. Based on l,

$${F}_{NM} {D}_{NM} ( - {\overline{v}}_{l}^{Detail} ) \vec{y}$$

may be calculated as a circular shifted value from a value, down-sampled from F_{NMZ}_{_{M}}[:,0:NM−1]\vec{y} by Z_{M}, by l+g_{ν}MZ_{M}. For each of l=0, 1 . . . . MZ_{M}−1, inter-element multiplication of

$${F}_{NM} {D}_{NM} ( - {\overline{v}}_{l}^{Detail} ) \vec{y} and {{f}_{s}}^{\to *}$$

calculated by using the process described above (expressed as ⊙ in Formula 8) may be performed, and g_{τ}th partial IFFT may be performed for each row. In Formula 8,

$${\overline{v}}_{l}^{Detail}$$

may mean a grid tor the Doppler axis of the search region according to the detail search mode, and

$$( {\overline{τ}}_{i}^{Detail} , {\overline{v}}_{l}^{Detail} )$$

that is a grid of the search region according to the detail search mode may be expressed as Formula 9 below. Formula 9 may be understood with reference to the descriptions given above, and thus detailed descriptions thereof are omitted.

$$( {\overline{τ}}_{i}^{Detail} , {\overline{v}}_{l}^{Detail} ) = ( \frac{i + {g}_{τ} {NZ}_{N}}{{NMZ}_{N}} , \frac{l + {g}_{v} {MZ}_{M}}{{MNZ}_{M}} ) , \\ 0 \leq i \leq {NZ}_{N} - 1 , 0 \leq l \leq {MZ}_{M} - 1 \qquad [ Formula 9 ]$$

As described above, the sensing apparatus according to the inventive concepts may estimate the target more precisely as the sensing apparatus operates in a detail search mode. The sensing apparatus may estimate the target more precisely than when operating in the partial search mode, by adjusting the number of grids included in the detail search region greater than the number of grids included in the search region according to the partial search mode, based on the oversampling factors (Z_{N} and Z_{M}).

Although the target estimation circuits 110a, 110b, and 110c described above with reference to FIGS. 4, 7, and 10 are illustrated and described to include different components, this is for convenience of explanation, and a target estimation circuit according to the inventive concepts are not limited thereto. For example, the target estimation circuit according to the inventive concepts may include one circuit capable of performing all operations of the target estimation circuits 110a, 110b, and 110c respectively described above with reference to FIGS. 4, 7, and 10. In addition, the Formulas 1 through 9 are intended to explain embodiments according to the inventive concepts, and the technical idea of the inventive concepts is not limited thereto.

FIG. 11 is a diagram of the search region in the detail search mode according to embodiments.

FIG. 11 is a diagram of the search region according to the detail search mode described above with reference to FIG. 10.

Referring to FIGS. 8 and 11 together, because the area of the search region according to the detail search mode and the area of the search region according to the partial search mode are determined by the symbol time ST and the sub-carrier spacing SS allocated to the OTFS transmitted signal, they may be the same (or similar). However, in the detail search mode, the sensing apparatus may oversample the search region based on the oversampling factors (Z_{N} and Z_{M}). Thus, because the spectrum matrix

$${H}_{{g}_{τ} , {g}_{v}}^{Detail}$$

generated in the detail search mode includes more elements than the spectrum matrix

$${H}_{{g}_{τ} , {g}_{v}}^{Partial}$$

generated in the partial search mode, the sensing apparatus may estimate the target more precisely in the detail search mode. For example, the number of elements included in the spectrum matrix

$${H}_{{g}_{τ} , {g}_{v}}^{Detail}$$

may be Z_{N}×Z_{M} times the number of elements included in the spectrum matrix

$${H}_{{g}_{τ} , {g}_{v}}^{Partial} .$$

In the inventive concepts, a grid, for example, the grid in FIG. 5, which is uniformly divided by the oversampling factors Z_{N} and Z_{M} may be referred to as a sub-grid.

FIG. 11 and the example described above with reference to FIG. 11 may be only for describing the search region according to the inventive concepts, and thus the search region according to the inventive concepts is not limited thereto. As described above, the search region according to the inventive concepts may vary according to the bandwidth BW and frame time FT of the OTFS transmitted signal, and the number of uniform grids included in the search region may also vary based on the number of symbols M and the number N of sub-carriers allocated to the OTFS transmitted signal.

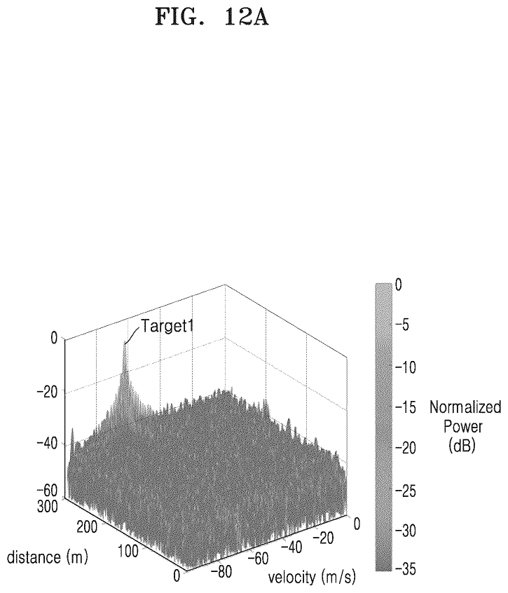

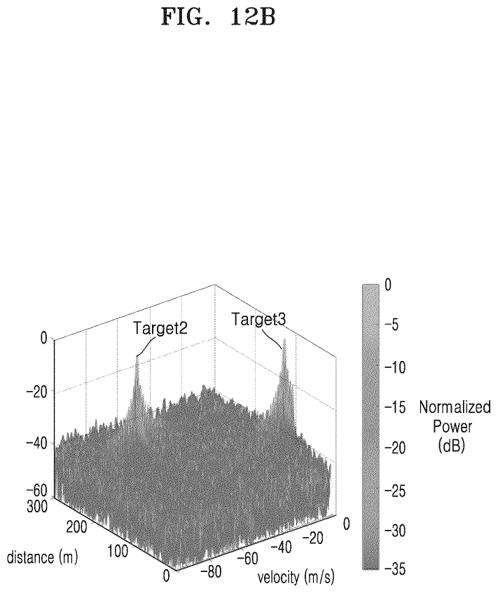

FIGS. 12A and 12B are diagrams illustrating spectra corresponding to spectrum matrices in the detail search mode, according to embodiments.

FIGS. 12A and 12B are diagrams of spectra corresponding to the spectrum matrix

$$( {H}_{{g}_{τ} , {g}_{v}}^{Detail}$$

in FIG. 10) calculated in the detail search mode described above with reference to FIGS. 10 and 11, respectively. FIGS. 12A and 12B may correspond to FIGS. 9A and 9B described above, respectively, may have the oversampling factors Z_{N} and Z_{M} as 4, respectively, and may represent spectra for the same search regions (or identical search regions or similar search regions) in FIGS. 9A and 9B, respectively. In other words, FIG. 12A may represent a spectrum for the search region corresponding to g_{τ}=0 and g_{ν}=−1, and FIG. 12B may represent a spectrum for the search region corresponding to g_{τ}=0 and g_{ν}=0.

Comparing FIGS. 12A, 12B, 9A, and 9B to each other, it may be understood that the target estimation according to the detail search mode is more precise than the target estimation according to the partial search mode, as described above. Thus, the estimation accuracy for the target may be higher in the detail search mode than in the partial search mode.

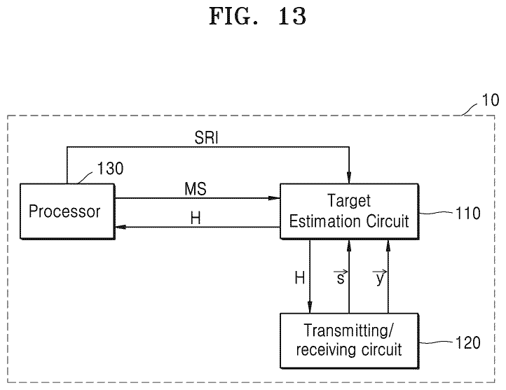

FIG. 13 is a block diagram of the sensing apparatus 10 according to embodiments.

Because the sensing apparatus 10 of FIG. 13 corresponds to the sensing apparatus 10 of FIG. 2, duplicate descriptions thereof are omitted.

Referring to FIG. 13, the transmitting/receiving circuit 120 may output the OTFS transmission symbol vector \vec{s} and the OTFS reception symbol vector \vec{y} to the target estimation circuit 110, and the target estimation circuit 110 may calculate the spectrum matrix H based on the OTFS transmission symbol vector \vec{s} and the OTFS reception symbol vector \vec{y}.

The target estimation circuit 110 according to the inventive concepts may output the spectrum matrix H to the processor 130 and the transmitting/receiving circuit 120. The processor 130 may generate search region information SRI based on the spectrum matrix H, and output the search region information SRI to the target estimation circuit 110. The search region information SRI may include information indicating the search region.

The sensing apparatus 10 according to the inventive concepts may perform the target sensing operation at frame time intervals. The processor 130 according to embodiments of the inventive concepts may obtain information about the target (the distance between the sensing apparatus 10 and the target and the velocity of the target) estimated at a first time point based on the spectrum matrix H. The processor 130 may determine the search region at a second time point (for example, a time point from a first time point after the frame time) based on the information about the target estimated at the first time point.

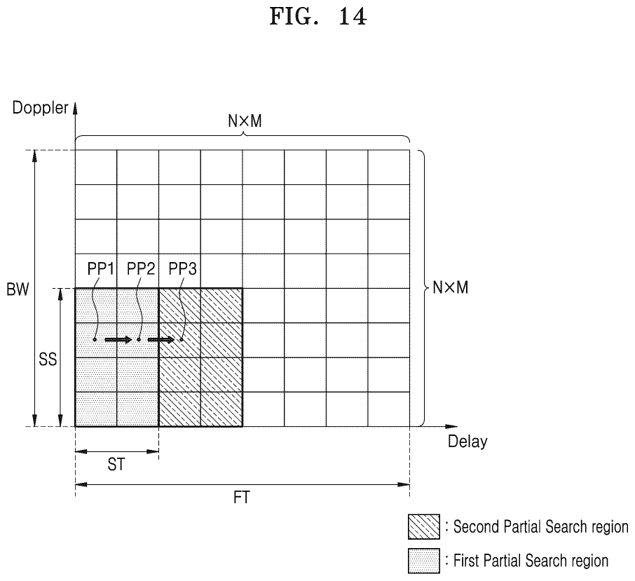

FIG. 14 is a diagram for explaining a change of a search region according to embodiments.

FIG. 14 will be described with reference to FIG. 13 together. Referring to FIGS. 14 and 13 together, the sensing apparatus 10 may operate in the partial search mode at the first time point to calculate a first spectrum matrix for a first partial search region. The processor 130 may determine a first peak-point PP1 based on the first spectrum matrix, and estimate a target corresponding to the first peak-point PP1. At a second time point that is a time point after one frame time from the first time point, the sensing apparatus 10 may operate in the partial search mode to calculate a second spectrum matrix for the first partial search region. The processor 130 may determine a second peak-point PP2 based on the second spectrum matrix, and estimate the target corresponding to the second peak-point PP2. The sensing apparatus 10 according to embodiments may track the target based on the first spectrum matrix and the second spectrum matrix.

The sensing apparatus 10 according to embodiments of the inventive concepts may predict information of the target (the distance between the sensing apparatus 10 and the target and the velocity of the target) at a third time point after one frame time from the second time point, based on the first spectrum matrix and the second spectrum matrix. For example, the processor 130 may predict a third peak-point PP3 based on a change from the first peak-point PP1 to the second peak-point PP2. At a third time point, the processor 130 may output to the target estimation circuit 110 search region information SRI indicating the second search region to calculate a third spectrum matrix for the second partial search region including the predicted third peak-point PP3. The search region information SRI according to the inventive concepts is not limited thereto, and the search region information SRI may indicate a search region including a second partial search region for stability of the target estimation operation and/or the tracking operation. For example, the processor 130 may output the search region information SRI indicating the first partial search region and the second partial search region to the target estimation circuit 110.

The first, second, and third spectrum matrices may be generated through calculation of spectrum matrices in the above-described partial search mode (for partial search regions corresponding to the respective spectrum matrices), with reference to, for example, FIG. 3. For example, the sensing apparatus 10 may estimate a distance to a target and a velocity of the target based on the first spectrum matrix and the second spectrum matrix. The sensing apparatus 10 may predict the distance to the target and the velocity of the target at a time point after a predetermined time (e.g., a third time point that is one frame time after the second time point) based on the estimated distance and velocity. The sensing apparatus 10 may determine a partial search region corresponding to the predicted distance and velocity, and may estimate the target at the third time point by generating a third spectrum matrix corresponding to the determined partial search region based on the above-described method.

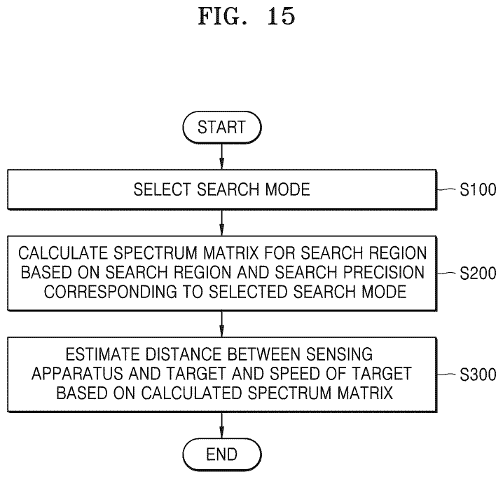

FIG. 15 is a flowchart of an operation of the sensing apparatus 10 according to embodiments.

Referring to FIG. 15, the sensing apparatus 10 according to the inventive concepts may select the search mode in operation S100. As described above, the sensing apparatus 10 according to the inventive concepts may select any one search mode of the total search mode, the partial search mode, and/or the detail search mode. The total search region according to the inventive concepts may be determined based on the frame time and the bandwidth of the OTFS transmitted signal, and the total search region may be the same as (or similar to) the search region according to the total search mode (refer to FIG. 5). The partial search region according to the partial search mode may include a partial region of the total search region (refer to FIG. 8). The area of the detail search region according to the detail search mode may be the same as (or similar to) the area of the partial search region according to the partial search region (refer to FIGS. 8 and 11 together).

In operation S200, the sensing apparatus 10 may calculate the spectrum matrix for the search region based on the search region and the search precision corresponding to the selected search mode. Description of the search region for each of the total search mode, the partial search mode, and the detail search mode may overlap with descriptions given above, and thus are omitted. The sensing apparatus 10 according to the inventive concepts may divide the total search region into a plurality of uniform grids, based on the number of symbols and the number of sub-carriers allocated to the OTFS transmitted signal. The sensing apparatus 10 operating in the detail search mode may uniformly divide the uniformly divided grids included in the search region based on the oversampling factors (Z_{N} and Z_{M} described above) (refer to FIG. 11). In the inventive concepts, the search precision may be defined as the number of grids included in the same area (or a similar area). Accordingly, the search precision of the total search mode and the partial search mode may be the same (or similar), and the search precision of the detail search mode may be higher than that of the total search mode and the partial search mode. For example, referring to FIGS. 5, 8, and 11 together, the number of the grids included in the first search region according to the partial search mode of FIG. 8 is 8. The number of grids included in the same region as (or a similar region to) the first search region of FIG. 8 may be 8 in the total search mode (refer to FIG. 5), and 32 in the detail search mode (refer to FIG. 11).

In operation S300, the sensing apparatus 10 may estimate the distance between the sensing apparatus 10 and the target and the velocity of the target based on the calculated spectrum matrix. The sensing apparatus 10 according to the inventive concepts may operate in the total search mode, and may perform the target estimation operation with lower complexity by dividing the total search region into a plurality of uniform grids based on the number of symbols and the number of sub-carriers allocated to the OTFS transmitted signal and calculating the spectrum matrix including elements respectively corresponding to the plurality of uniform grids. The sensing apparatus 10 according to the inventive concepts may operate in the partial search mode, and the plurality of grids according to the partial search mode may be the same as (or similar to) the plurality of grids according to the total search mode. However, the sensing apparatus 10 operating in the partial search mode may select the partial search region corresponding to the symbol time ST and a frequency interval of the OTFS transmitted signal among the total search region, and estimate the target in the partial search region by calculating the spectrum matrix for the plurality of grids included in the partial search region. The sensing apparatus 10 according to the inventive concepts may operate in the detail search mode, and the interval between each of the plurality of grids included in the detail search region according to the detail search mode may be less than the interval between each of the plurality of grids included in the search region according to the total search mode and the partial search mode. Accordingly, precision of the target estimation according to the detail search mode may be higher than precision of the target estimation according to each of the total search mode and the partial search mode.

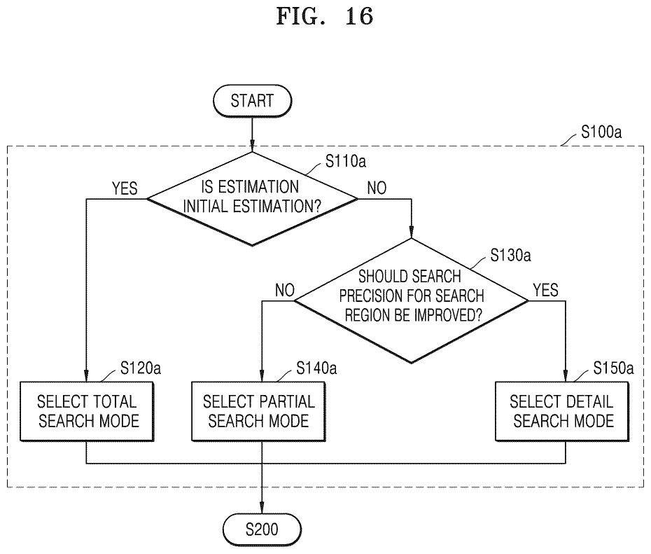

FIG. 16 is a flowchart of an operation of the sensing apparatus 10 for determining a search mode, according to embodiments.

Operation S100a in FIG. 16 may correspond to operation S100 described above with reference to FIG. 15.

Referring to FIG. 16, the sensing apparatus 10 according to the inventive concepts may determine whether the estimation is a first target estimation in operation S110a. In the inventive concepts, an initial target estimation may be used as having the same meaning as (or a similar meaning to) an initial target search.

According to the determination of the initial target estimation in operation S110a, the sensing apparatus 10 according to the inventive concepts may select the total search mode (operation S120a). When the target is initially estimated, because there is no information about the number of targets, the distance between the sensing apparatus and the target, and the velocity of the target, it may be necessary (or otherwise, desirable) to sense all possible targets by operating in the total search mode. When the target estimation operation has been previously performed, the sensing apparatus 10 according to the inventive concepts may predict a search region to which a peak-point is to be included based on the target estimation result, and thus may select the partial search mode for lower-complexity computation. However, the inventive concepts are not limited thereto, and for example, depending on the purpose (or implementation) of a sensing apparatus and/or the type of target to be sensed, the sensing apparatus may perform the initial target estimation operation of the target in the partial search mode or the detail search mode.

According to the determination that the target estimation operation is not the initial target estimation operation in operation S110a, the sensing apparatus 10 according to the inventive concepts may determine whether it is necessary to improve the search precision (or whether the search precision should be improved) for the search region (operation S130a).

According to the determination that it is not necessary to improve the search precision (or that the search precision should not be improved) for the search region in operation S130a, the sensing apparatus 10 according to the inventive concepts may select the partial search mode (operation S140a).

According to the determination that it is necessary to improve the search precision (or that the search precision should be improved) for the search region in operation S130a, the sensing apparatus 10 according to the inventive concepts may select the detail search mode (operation S150a). The sensing apparatus 10 according to embodiments of the inventive concepts may select the detail search mode to improve the search precision, when there are no element corresponding to the peak-point among the elements included in the spectrum matrix according to the previously estimated result, or when the number of elements corresponding to the peak-point is greater than a certain threshold value.

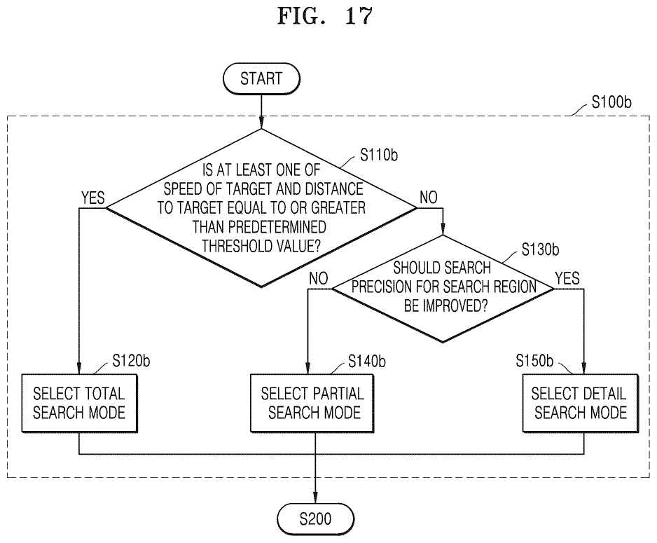

FIG. 17 is a flowchart of an operation of the sensing apparatus 10 for determining a search mode, according to embodiments.

Operation S100b in FIG. 17 may correspond to operation S100 described above with reference to FIG. 15. Because operations S120b, S140b, and S150b of FIG. 17 correspond to operations S120a, S140a, and S150a described above with reference to FIG. 16, respectively, duplication descriptions thereof are omitted.

Referring to FIG. 17, in operation S110b, the sensing apparatus 10 according to the inventive concepts may determine whether at least one of the velocity of the target and the distance to the target is equal to or greater than a certain threshold value. In general, the target to be sensed based on the OTFS transmitted signal may be highly likely to be sensed in the first search region in FIG. 8 (having the symbol time ST and the sub-carrier spacing SS). Accordingly, when at least one of the velocity of the target and the distance to the target is less than the certain threshold value, it may be highly probable to estimate the target by calculating the spectrum matrix for the partial search region, and thus the sensing apparatus 10 may operate in the partial search mode with lower-complexity calculation.

According to the determination that at least one of the velocity of the target and/or the distance to the target is equal to or greater than the certain threshold value in operation S110b, the sensing apparatus 10 according to the inventive concepts may select the total search mode (operation S120b).

According to the determination that at least one of the velocity of the target and the distance to the target is less than the certain threshold value in operation S110b, the sensing apparatus 10 according to the inventive concepts may determine whether it is necessary to improve the search precision (or whether the search precision should be improved) for the search region (operation S130b).

According to the determination that it is not necessary to improve the search precision (or that the search precision should not be improved) for the search region in operation S130b, the sensing apparatus 10 according to the inventive concepts may select the partial search mode (operation S140b).

According to the determination that it is necessary to improve the search precision (or that the search precision should be improved) for the search region in operation S130b, the sensing apparatus 10 according to the inventive concepts may select the detail search mode (operation S150b).

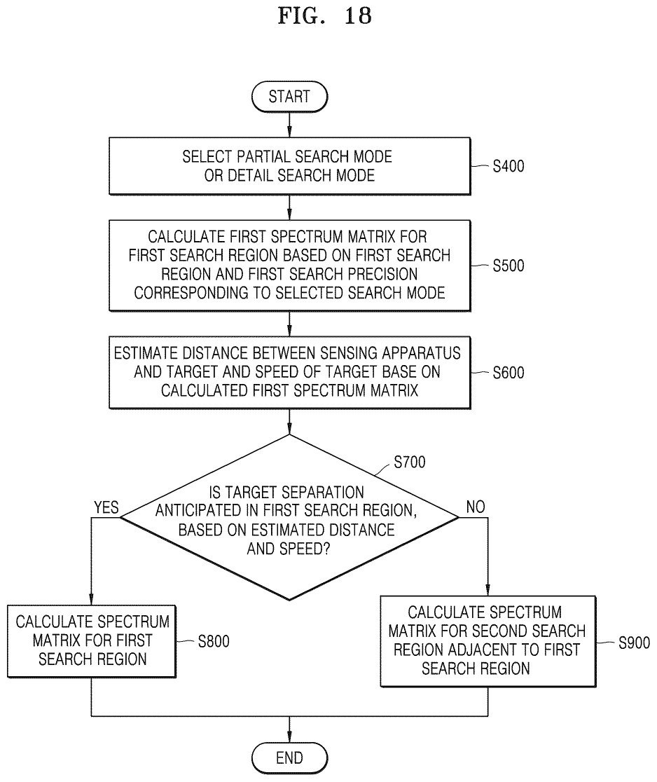

FIG. 18 is a flowchart of an operation of the sensing apparatus 10 for a target tracing operation in a search mode, according to embodiments.

FIG. 18 may be described with reference to FIGS. 13 and 14, and duplicate descriptions thereof may be omitted.

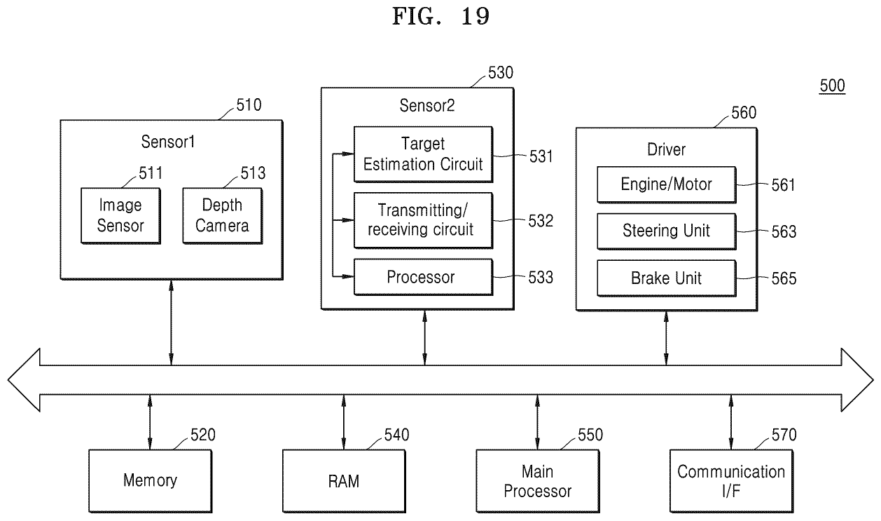

Referring to FIG. 19, the sensing apparatus 10 according to the inventive concepts may select the partial search mode or the detail search mode in operation S400.

In operation S500, the sensing apparatus 10 may calculate the first spectrum matrix for the first search region based on the first search region and first search precision corresponding to the selected search mode.

In operation S600, the sensing apparatus 10 may estimate the distance to the target and the velocity of the target based on the calculated the first spectrum matrix.

In operation S700, the sensing apparatus 10 may determine whether target separation is anticipated from the first search region based on the estimated distance and velocity.

According to the determination that the target separation from the first search region is anticipated in operation S700, the sensing apparatus 10 according to the inventive concepts may calculate the spectrum matrix for the first search region (operation S800). Calculation of the first spectrum matrix for the first search region in operation S500 may be performed at the first time point, and calculation of the first spectrum matrix for the first search region in operation S800 may be performed at the second time point one frame time after the first time point.

According to the determination that the target separation from the first search region is not anticipated in operation S700, the sensing apparatus 10 according to the inventive concepts may calculate the spectrum matrix for the second search region (operation S900).

As described above with reference to FIGS. 13 and 14, the sensing apparatus 10 according to the inventive concepts may predict the target estimation result (for example, PP3 in FIG. 14) based on the target estimation result (for example, PP1 and PP2 in FIG. 14), and when the predicted target estimation result is out of the search region, may determine an adjacent region (e.g., the second search region) as the search region.

FIG. 19 is a diagram of a vehicle system 500 (may also be referred to herein as an autonomous vehicle 500) configured to perform a target search operation according to embodiments.

Referring to FIG. 19, the autonomous vehicle 500 may include a first sensor 510, a memory 520, a second sensor 530, a random access memory (RAM) 540, a main processor 550, a driver 560, and/or a communication interface 570, and components of the autonomous vehicle 500 may be connected to communicate with each other via a bus. In this case, the memory 520 may correspond to the memory described above with reference to FIG. 1, and the second sensor 530 may include a target estimation circuit 531, a transmitting/receiving circuit 532, and/or a processor 533 according to the inventive concepts. The second sensor 530 may correspond to the sensing apparatus 10 described above, and the target estimation circuit 531, the transmitting/receiving circuit 532, and the processor 533 may correspond to the target estimation circuit 110, the transmitting/receiving circuit 120, and the processor 130 in FIG. 1, respectively. As described above with reference to FIGS. 1 through 18, the second sensor 530 may divide the search region into the plurality of uniform grids based on the number of symbols and the number of sub-carriers allocated to the OTFS transmitted signal, and may calculate the spectrum matrix including elements corresponding to the plurality of divided grids. The second sensor 530 may estimate the target based on the calculated spectrum matrix, and estimate the distance to the target and the velocity of the target. The second sensor 530 may output to the main processor 550 via the bus the target estimation result (information about the distance to the target and the velocity of the target). The main processor 550 may control the operation of the autonomous vehicle 500 related with an autonomous driving based on the target estimation result.

The autonomous vehicle 500 may include the first sensor 510 in addition to the second sensor 530 according to the inventive concepts. The first sensor 510 may include a plurality of sensors that generate information about the surrounding environment of the autonomous vehicle 500. For example, the first sensor 510 may include the plurality of sensors that receive image signals regarding the surrounding environment of the autonomous vehicle 500 and output the received image signals as images. The first sensor 510 may include an image sensor 511, such as a charge coupled device (CCD) and a component metal oxide semiconductor (CMOS), a depth camera 513, etc. In embodiments, the image sensor 511 may generate a front image of the autonomous vehicle 500, and provide the generated front image to the main processor 550.

The memory 520, as a storage location for storing data, may store, for example, various data generated in operation performance processes of the main processor 550 and the processor 533. The processor 533 according to embodiments of the inventive concepts may not be included in the second sensor 530, and may include a separate component for transceiving data to and from the second sensor 530 via the bus.

The main processor 550 may control the overall operation of the autonomous vehicle 500. For example, the main processor 550 may control functions of the processor 533 by executing programs stored in the RAM 540. The RAM 540 may temporarily store programs, data, applications, or instructions.

In addition, the main processor 550 may control the operation of the autonomous vehicle 500 based on the calculation result of the processor 533. In embodiments, the main processor 550 may receive information about the distance between the autonomous vehicle 500 and the target and the velocity of the target, and the target from the processor 533, and may control the operation of the driver 560 based on the received information about the location and velocity.

The driver 560, as a component to drive the autonomous vehicle 500, may include an engine/motor 561, a steering unit 563, and/or a brake unit 565. In embodiments, the driver 560 may adjust thrust, brake, velocity, direction, or the like of the autonomous vehicle 500 by using the engine/motor 561, the steering unit 563, and/or the brake unit 565 under the control of the processor 533. According to embodiments, for example, the processor 533 may control the driver 560 to reduce a power of the engine/motor 561, cause the steering unit 563 to steer the autonomous vehicle 500 in a direction away from the target, and/or cause the brake unit 565 to activate a brake and slow the autonomous vehicle 500 in response to determining the autonomous vehicle 500 will collide with the target based on the distance between the autonomous vehicle 500 and the target and the velocity of the target.

The communication interface 570 may communicate with an external device by using a wired or wireless communication method. For example, the communication interface 570 may communicate by using a wired communication method such as Ethernet, or by using a wireless communication method such as Wi-Fi and Bluetooth.

In embodiments of the inventive concepts, the communication interface 570 may transceive the OFDM signals. In embodiments of the inventive concepts, the communication interface 570 may transceive the OTFS signal to/from the transmitting/receiving circuit 532. Referring to FIG. 19, the communication interface 570 is illustrated as a separate component from the transmitting/receiving circuit 532 and to transceive data via the bus, but this is for convenience of explanation and the inventive concepts are not limited thereto.

Embodiments of the inventive concepts described above with reference to FIGS. 1 through 18 may be applied not only to the autonomous vehicle 500 described above with reference to FIG. 19, but to various apparatus in various fields for sensing targets and/or sensing targets moving at high speed in a high speed situation.

In embodiments of the inventive concepts described above with reference to FIGS. 1 through 19, a hardware-based approach method has been described as an example. However, because embodiments of the inventive concepts may include technology using both hardware and software, embodiments of the inventive concepts may not exclude a software-based approach method.

Conventional devices and methods for estimating a position and velocity of a target using orthogonal time-frequency space (OTFS) signals involve performing a two-dimensional search algorithm for each path in a delay-Doppler (DD) region. This estimation involves an excessive amount of calculation. Accordingly, the conventional devices and methods consume excessive resources (e.g., power, processor, memory, delay, etc.).

However, according to embodiments, improved devices and methods are provided for estimating a position and velocity of a target using OTFS signals. For example, the improved devices and methods involve calculating a spectrum matrix for only a portion of a total search region. The reduced search region also reduces the amount of calculation performed to performing the estimation. Accordingly, the improved devices and methods overcome the deficiencies of the conventional devices and methods to at least reduce resource consumption (e.g., power, processor, memory, delay, etc.).

According to embodiments, an autonomous vehicle includes a processor and a sensing system, the sensing system including a transmitting/receiving circuit configured to transmit an orthogonal time frequency space (OTFS) transmitted signal to at least one target, and receive an OTFS received signal, the OTFS received signal corresponding to the OTFS transmitted signal having been reflected by the at least one target, and processing circuitry configured to calculate a first spectrum matrix in a delay-Doppler domain based on the OTFS transmitted signal and the OTFS received signal, and estimate a first distance to the at least one target and a first velocity of the at least one target based on a plurality of first elements included in the first spectrum matrix, the plurality of first elements respectively corresponding to at least some of a first plurality of grids configured to divide uniformly a total search region, and the total search region corresponding to a bandwidth and a frame time of the OTFS transmitted signal in the delay-Doppler domain, and the processor being configured to control the autonomous vehicle based on the first distance to the at least one target and the first velocity of the at least one target.

According to embodiments, operations described herein as being performed by the sensing system 1, the sensing apparatus 10, the target estimation circuit 110, the transmitting/receiving circuit 120, the processor 130, the ISFFT circuit 121_1, the IFFT circuit 122_1, the windowing circuit 123_1, the PTS circuit 124_1, the CP addition circuit 125_1, the CP removal circuit 125_2, the STP circuit 124_2, the FFT circuit 122_2, the SFFT circuit 121_2, the channel equalization circuit 126, the target estimation circuit 110a, the NM-FFT circuit 111a, the conjugation circuit 112a, each of the two of diagonalization circuits 113a and 114a, the row (R)-FFT R-FFT circuit 116a, the column (C)-IFFT C-IFFT circuit 117a, the R-FFT shift circuit 118a, the target estimation circuit 110b, each of the two of NM-FFT circuits 111b and 113b, the conjugation circuit 112b, the n-circular shift circuit 114b, the PTS circuit 115b, the EWM circuit 116b, the partial C-IFFT circuit 117b, the target estimation circuit 110c, each of the two of zero padding circuits 117c and 119c, the NM-FFT circuit 111c, the Hermitian circuit 112c, the NMZM-FFT circuit 113c, the n-circular shift circuit 114c, the PTS circuit 115c, a EWM circuit 116c, the partial C-IFFT circuit 118c, the autonomous vehicle 500, the main processor 550, the communication interface 570, the target estimation circuit 531, the transmitting/receiving circuit 532, and/or the processor 533 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

According to embodiments each respective circuit among the circuits discussed in connection with FIGS. 3, 4, 7 and 10 may be configured to perform an operation consistent with the naming of the respective circuit.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 520). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

As described above, embodiments have been disclosed in the drawings and the specification. While embodiments have been described herein with reference to specific terms, it should be understood that they have been used only for the purpose of describing the technical idea of the inventive concepts and not for limiting the scope of the inventive concepts as defined in the claims. Thus, those with ordinary skill in the art will appreciate that various modifications and equivalent examples are possible without departing from the scope of the inventive concepts. Therefore, the true scope of protection of the inventive concepts should be determined by the technical idea of the appended claims.

What is claimed is:

1. A sensing apparatus comprising:
a transmitting/receiving circuit configured to,
transmit an orthogonal time frequency space (OTFS) transmitted signal to at least one target, and
receive an OTFS received signal, the OTFS received signal corresponding to the OTFS transmitted signal having been reflected by the at least one target; and
processing circuitry configured to,
calculate a first spectrum matrix in a delay-Doppler domain based on the OTFS transmitted signal and the OTFS received signal, and
estimate a first distance to the at least one target and a first velocity of the at least one target based on a plurality of first elements included in the first spectrum matrix, the plurality of first elements respectively corresponding to at least some of a first plurality of grids configured to divide uniformly a total search region, and the total search region corresponding to a bandwidth and a frame time of the OTFS transmitted signal in the delay-Doppler domain.

2. The sensing apparatus of claim 1, wherein
the total search region is divided into the first plurality of grids based on a number of symbols and a number of sub-carriers allocated to the OTFS transmitted signal.

3. The sensing apparatus of claim 2, wherein the plurality of first elements respectively correspond to all of a plurality of second elements included in the total search region.

4. The sensing apparatus of claim 2, wherein
the plurality of first elements respectively correspond to a second plurality of grids in a first partial search region that corresponds to a symbol time and a sub-carrier spacing of the OTFS transmitted signal, the first partial search region corresponding to a portion of the total search region.

5. The sensing apparatus of claim 4, wherein the processing circuitry is configured to:
calculate a second spectrum matrix comprising a plurality of second elements respectively corresponding to a third plurality of grids included in a second partial search region based on the first distance to the at least one target and the first velocity of the at least one target, the second partial search region being adjacent to the first partial search region; and
estimate a second distance to the at least one target and a second velocity of the at least one target based on the plurality of second elements in the second spectrum matrix.

6. The sensing apparatus of claim 2, wherein
the plurality of first elements in the first spectrum matrix respectively correspond to a plurality of sub-grids respectively oversampled from each of the first plurality of grids, the plurality of sub-grids corresponding to a symbol time and a sub-carrier spacing of the OTFS transmitted signal, the plurality of sub-grids corresponding to a portion of the total search region, and the plurality of sub-grids being included in a partial search region.

7. A method of operating a sensing apparatus, the method comprising:
transmitting an orthogonal time frequency space (OTFS) transmitted signal to at least one target;
receiving an OTFS received signal, the OTFS received signal corresponding to the OTFS transmitted signal having been reflected by the at least one target;
selecting a search mode to obtain a selected search mode;
calculating a first spectrum matrix in a delay-Doppler domain based on the OTFS transmitted signal, the OTFS received signal, a search region and a search precision, the search region and the search precision corresponding to the selected search mode; and
estimating a first distance to the at least one target and a first velocity of the at least one target based on a plurality of first elements included in the first spectrum matrix, the search region including a first plurality of grids, the first plurality of grids being uniform, and the plurality of first elements respectively corresponding to the first plurality of grids.

8. The method of claim 7, wherein
the selecting of the search mode includes selecting a total search mode; and
the calculating includes calculating the first spectrum matrix for a total search region, the total search region corresponding to a bandwidth and a frame time of the OTFS transmitted signal, and the total search region being divided into the first plurality of grids based on a number of symbols and a number of sub-carriers allocated to the OTFS transmitted signal.

9. The method of claim 8, wherein
the number of symbols allocated to the OTFS transmitted signal is M;
the number of sub-carriers allocated to the OTFS transmitted signal is N; and
the number of the first plurality of grids is MN×MN.

10. The method of claim 7, wherein
the selecting of the search mode includes selecting a total search mode based on an estimation of the first distance to the at least one target and the first velocity of the at least one target being an initial estimation; and
the search region is a total search region corresponding to a bandwidth and a frame time of the OTFS transmitted signal, the total search region being divided into the first plurality of grids based on a number of symbols and a number of sub-carriers allocated to the OTFS transmitted signal.

11. The method of claim 7, wherein
the selecting of the search mode includes selecting a partial search mode; and
the calculating includes calculating the first spectrum matrix for a first partial search region corresponding to a first portion of a total search region, the total search region corresponding to a bandwidth and a frame time of the OTFS transmitted signal is calculated, a size of the first partial search region corresponding to a sub-carrier spacing and a symbol time of the OTFS transmitted signal, the first partial search region is divided into the first plurality of grids based on a number of symbols and a number of sub-carriers allocated to the OTFS transmitted signal.

12. The method of claim 11, wherein
the number of symbols allocated to the OTFS transmitted signal is M;
the number of sub-carriers allocated to the OTFS transmitted signal is N; and
the number of the first plurality of grids included in the first partial search region is M×N.

13. The method of claim 11, further comprising:
calculating a second spectrum matrix in the delay-Doppler domain corresponding to a second partial search region adjacent to the first partial search region based on the first distance to the at least one target and the first velocity of the at least one target, the second partial search region corresponding to a second portion of the total search region; and
estimating a second distance to the at least one target and a second velocity of the at least one target based on a plurality of second elements included in the second spectrum matrix, an area of the second partial search region and a number of a second plurality of grids included therein being identical to an area of the first partial search region and a number of the first plurality of grids included therein.

14. The method of claim 7, wherein
the selecting of the search mode includes selecting a detail search mode; and
the calculating includes calculating the first spectrum matrix for a detail search region corresponding to a portion of a total search region, the total search region corresponding to a bandwidth and a frame time of the OTFS transmitted signal, and a size of the detail search region corresponding to a sub-carrier spacing and a symbol time of the OTFS transmitted signal, the detail search region being divided into the first plurality of grids based on a number of symbols and a number of sub-carriers allocated to the OTFS transmitted signal, each of the first plurality of grids including a plurality of sub-grids, the plurality of sub-grids being uniform, and the plurality of first elements respectively correspond to the plurality of sub-grids.

15. The method of claim 14, wherein
the number of symbols allocated to the OTFS transmitted signal is M;
the number of sub-carriers allocated to the OTFS transmitted signal is N; and
the number of the plurality of sub-grids included in the detail search region is greater than M×N.

16. A sensing apparatus comprising:
a transmitting/receiving circuit configured to,
transmit an orthogonal time frequency space (OTFS) transmitted signal to at least one target, and
receive an OTFS received signal, the OTFS received signal corresponding the OTFS transmitted signal having been reflected by the at least one target; and processing circuitry configured to,
calculate a first spectrum matrix in a delay-Doppler domain based on the OTFS transmitted signal and the OTFS received signal, and
estimate a first distance to the at least one target and a first velocity of the at least one target based on a plurality of first elements included in the first spectrum matrix, a number of symbols allocated to the OTFS transmitted signal being M, a number of sub-carriers allocated to the OTFS transmitted signal being N, a total search region corresponding to a bandwidth and a frame time of the OTFS transmitted signal in the delay-Doppler domain including MN×MN grids, the MN×MN grids being uniform, and a number of the plurality of first elements is equal to or less than MN×MN.

17. The sensing apparatus of claim 16, wherein
the number of the plurality of first elements is MN×MN; and
the plurality of first elements respectively correspond to the MN×MN grids.

18. The sensing apparatus of claim 16, wherein
the number of the plurality of first elements is M×N; and
the plurality of first elements respectively correspond to M×N grids in a first partial search region corresponding to a sub-carrier spacing and a symbol time of the OTFS transmitted signal, the first partial search region corresponding to a portion of the total search region.

19. The sensing apparatus of claim 18, wherein the processing circuitry is configured to:
calculate a second spectrum matrix including a plurality of second elements using the first distance to the at least one target and the first velocity of the at least one target, the plurality of second elements respectively corresponding to M×N grids included in a second partial search region adjacent to the first partial search region; and
estimate a second distance to the at least one target and a second velocity of the at least one target based on the plurality of second elements.

20. The sensing apparatus of claim 16, wherein
the number of the plurality of first elements is greater than M×N, and
the plurality of first elements respectively correspond to a plurality of sub-grids that are obtained by uniformly and respectively dividing M×N grids corresponding to a sub-carrier spacing and a symbol time of the OTFS transmitted signal, the M×N grids being included in a partial search region corresponding to a portion of the total search region.
